(19) United States
(12) Patent Application Publication
(10) Pub. No.: US 2025/0347612 A1
(43) Pub. Date: Nov. 13, 2025

(54) BLOOD IMAGING ANALYSIS SYSTEM AND METHOD THEREOF

(71) Applicant: SHENZHEN ANLV MEDICAL TECHNOLOGY CO., LTD, Shenzhen (CN)

(72) Inventors: Zhiping WANG, Shenzhen (CN); Yahui LIU, Shenzhen (CN); Chunshu WANG, Shenzhen (CN)

(73) Assignee: SHENZHEN ANLV MEDICAL TECHNOLOGY CO., LTD, Shenzhen (CN)

(21) Appl. No.: 19/278,706

(22) Filed: Jul. 23, 2025

Related U.S. Application Data
(63) Continuation of application No. PCT/CN2023/142619, filed on Dec. 28, 2023.

(30) Foreign Application Priority Data
Jan. 28, 2023 (CN) 202310042315.1

(51) Int. Cl. G01N 15/1433; G01N 15/01; G01N 15/075; G01N 15/14

(52) U.S. Cl. CPC G01N 15/1433; G01N 15/01; G01N 15/075; G01N 2015/012; G01N 2015/016; G01N 2015/1486

(57) ABSTRACT

A blood imaging analysis system includes a chip and an imaging analysis main system. The height of the chamber containing the test liquid in the chip is H; the area magnification factor of the camera module is K; the imaged area of the test area (S1) in the camera component is S2, and the unit pixel area is SK. A clear image including various blood cells or particles is obtained by satisfying S2=S1×K. The pixel count of S2 is M=S2/SK. The imaged area (S2) is obtained by calculating the pixel count (M). The image matching analysis and processing of the blood cells or particles in the imaged area (S2) is carried out to achieve classification recognition and counting, and the count (CN) of different types of blood cells or particles in the volume (S1×H) is obtained.

### CROSS-REFERENCE TO RELATED APPLICATIONS

The present application is a continuation-application of International (PCT) Patent Application No. PCT/CN2023/142619 filed on Dec. 28, 2023, which claims priority benefits to Chinese Patent Disclosure No. 2023100423151, filed on Jan. 28, 2023, the contents of which are incorporated herein by reference.

### TECHNICAL FIELD

The present disclosure belongs to the technical field of imaging analysis of blood substances, and in particular to a blood imaging analysis system and a method for classifying, recognizing and counting cells based on bright-field microscopic magnification of stained cells.

### BACKGROUND

In the related art, there are different methods for analyzing the concentration and volume of various types of cells in blood cells. One method involves diluting the blood sample and then counting under a microscope using a hemocytometer. In related art, the hemocytometer, as illustrated in FIG. 11, has a cell counting area of a certain depth, with a grid of standard dimensions on the counting plate. Cell concentration is calculated by counting the count of cells falling within the grids. Typically, this counting process requires manual counting, which is time-consuming, labor-intensive, and prone to errors. Moreover, each hemocytometer requires very finely defined standard-sized grids, demanding high manufacturing accuracy and resulting in high implementation costs, making it unsuitable for large-scale blood sample analysis.

### SUMMARY

A first aspect of the present disclosure provides a blood imaging analysis system, including a chip and an imaging analysis main system. The imaging analysis main system includes a main control module, a chip carrier module, a camera module, a focusing module and a digital image processing module. The chip is arranged on the chip carrier module, the chip includes a test liquid receiving chamber for receiving a blood sample mixture, the test liquid receiving chamber is transparent from a top to a bottom, and a height of the test liquid receiving chamber is a preset chamber height value (H). The camera module includes a camera component and a microscopic magnification component, a magnification factor of the camera module is designated by K; a test area on the chip is designated by S1; an imaged area of the test area (S1) in the camera component is designated by S2, and a unit pixel area of the camera component is designated by SK. The focusing module is configured to drive the chip carrier module or the camera module to move relative to each other to allow the camera module to obtain a clear digital image, the digital image comprises a clear image of blood cells or particles in the blood sample mixture. The camera module is configured to obtain the clear digital image by satisfying a formula S2=S1×K; a pixel count (M) of S2 is calculated using a formula M=S2/SK. The digital image processing module is configured for digital image processing, the digital image processing module is configured to: obtain the imaged area (S2) by calculating the pixel count (M), classify and identify the blood cells or particles in the blood sample mixture by image matching analysis and processing of the blood cells or particles in the imaged area (S2), and obtain a count (CN) of the blood cells or particles in the volume (S1×H) by counting the blood cells or particles in the imaged area (S2).

A second aspect of the present disclosure provides an imaging analysis system, including a blood imaging analysis system. The blood imaging analysis system includes a chip and an imaging analysis main system. The imaging analysis main system includes a main control module, a chip carrier module, a camera module, a focusing module and a digital image processing module. The chip is arranged on the chip carrier module, the chip includes a test liquid receiving chamber for receiving a blood sample mixture, the test liquid receiving chamber is transparent from a top to a bottom, and a height of the test liquid receiving chamber is a preset chamber height value (H). The camera module includes a camera component and a microscopic magnification component, a magnification factor of the camera module is designated by K; a test area on the chip is designated by S1; an imaged area of the test area (S1) in the camera component is designated by S2, and a unit pixel area of the camera component is designated by SK. The focusing module is configured to drive the chip carrier module or the camera module to move relative to each other to allow the camera module to obtain a clear digital image, the digital image comprises a clear image of blood cells or particles in the blood sample mixture. The camera module is configured to obtain the clear digital image by satisfying a formula S2=S1×K; a pixel count (M) of S2 is calculated using a formula M=S2/SK. The digital image processing module is configured for digital image processing, the digital image processing module is configured to: obtain the imaged area (S2) by calculating the pixel count (M), classify and identify the blood cells or particles in the blood sample mixture by image matching analysis and processing of the blood cells or particles in the imaged area (S2), and obtain a count (CN) of the blood cells or particles in the volume (S1×H) by counting the blood cells or particles in the imaged area (S2).

A third aspect of the present disclosure provides a blood imaging analysis method, including the following steps: diluting and staining an original blood sample to obtain a blood sample mixture, wherein a dilution factor (P) of the blood sample mixture ranges from 10 to 400; adding the blood sample mixture into a test liquid receiving chamber of a chip, and precipitating blood cells or particles in the blood sample mixture to a bottom of the test liquid receiving chamber; wherein a height of the test liquid receiving chamber is a preset chamber height value (H); photographing the test liquid receiving chamber using a microscopic magnification digital imaging system with a magnification factor (K), wherein a unit pixel area in a microscopic magnification digital image obtained by the digital imaging system is SK, a test area on the chip is S1, and an imaged area of the test area (S1) in the microscopic magnification digital image system is S2; obtaining a clear microscopically magnified digital image by focusing a focus pattern or blood cells or particles at a bottom of the chip and satisfying a formula S2-S1×K; wherein a pixel count (M) of S2 is calculated using a formula M=S2/SK, the digital image comprises clear images of blood cells or particles in the blood sample mixture; obtaining the imaged area (S2) by calculating the pixel count (M), realizing classification and identification of the blood cells or particles in the blood sample mixture by image matching analysis and processing of the blood cells or particles in the imaged area (S2), and obtaining a count (CN) of the blood cells or particles in a volume of S1×H by counting the blood cells or particles in the imaged area (S2).

### BRIEF DESCRIPTION OF DRAWINGS

FIG. 1 is a block diagram of a blood imaging analysis system.

FIG. 2 is a block diagram of an optical path of a blood imaging analysis system.

FIG. 3 is a schematic diagram of an optical path principle of a blood imaging analysis system.

FIG. 4 is a schematic diagram of the relationship between a target area and an imaged area of a blood imaging analysis system.

FIG. 5 is a schematic diagram of combining multiple small target areas into a large target area.

FIG. 6 is a block diagram of a focusing module.

FIG. 7 is a block diagram of a camera module.

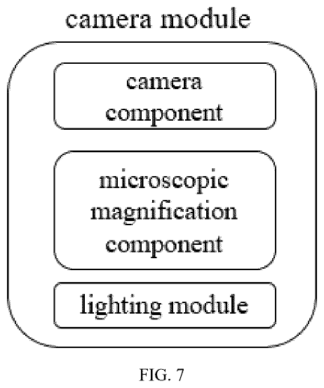

FIG. 8 is a block diagram of a digital image processing module.

FIG. 9 is a block diagram of a digital image processing module.

FIG. 10 is a top view of a chip.

FIG. 11 is a perspective view of a cell counting board in a counting system in the related art, and the right side is a partial enlarged view of its structure.

FIG. 12 is view of a standard chip, i.e., a schematic diagram of a resolution board.

### DETAILED DESCRIPTION OF THE EMBODIMENTS

The following is a further detailed description of the content of the present disclosure in conjunction with the accompanying drawings. It should be noted that the following is a description of some embodiments of the present disclosure and does not constitute any limitation to the present disclosure. The description of the embodiments of the present disclosure is only an explanation of the general principle of the present disclosure. The counts such as “first”, “second” and “A” and “B” involved in the present disclosure are only for the convenience of explanation and do not represent the order relationship in time or space. The combination of letters and counts “D1”, “K”, “SK”, “S1”, “S2”, “M” and “H” involved in the present disclosure are only for the convenience of explanation, and the specific meaning is determined by the specific words referred to.

In the related art, flow cytometers may also be configured to calculate cell volume and count. In electrical impedance flow cytometers, blood cells pass one by one through a narrow orifice. The environment inside and outside the orifice is a DC-powered electrolyte. When a cell passes through, it causes a transient change in electrical potential, forming an electrical pulse. The count of electrical pulses reflects the cell count, and the size of the pulse reflects the cell volume. Cells whose volume falls within a certain range are classified as target cells.

Other flow cytometers use optical or photochemical principles. Diluted and stained cells are injected into a sheath flow mechanism. Laser light irradiates the cells flowing through the sheath flow mechanism. Due to differences in cell characteristics, corresponding optical features are produced, such as specific scattering. Detecting the corresponding optical signals allows obtaining information about the volume and count of the cells.

However, the flow cytometers described above all require sequentially recognizing individual cells within a small sample. This necessitates designing precise fluidic channels and complex optical systems to capture photoelectric parameters from single cells. The system hardware design is complex and costly, and prone to frequent malfunctions. Regular maintenance is typically required to ensure the fluidic channels and optical systems remain in normal working condition. The single-cell flow channel results in low cell recognition efficiency. When the morphological characteristics of cells change, the accuracy of recognition decreases.

In the related art, blood cell analysis methods based on bright-field microscopic magnified digital images may classify different cell types in a blood sample based on the image. However, achieving precise classification, counting, and cell concentration calculation still faces many challenges. For ordinary blood sample mixture carrier chips based on direct cell spreading, since the digitally magnified microscopic image is enlarged, the requirement for the dimensional accuracy of the chip also increases accordingly. Producing chips with higher dimensional accuracy would increase manufacturing costs. How to perform recognition, counting of different cell types, and calculation of accurate concentrations for each type based on bright-field microscopic magnified digital images of ordinary carrier chips; the key lies in precisely acquiring the volume of the blood sample mixture in the imaged area. But determining the actual size corresponding to the captured image area in the digital image is a significant technical challenge.

Terminology: Magnification factor (K) in the present disclosure refers to the area magnification factor. Magnification factor (K) may be replaced by the square of a single linear magnification factor, or magnification factor (K) may be replaced by the product of the horizontal magnification factor and the vertical magnification factor.

To reduce the high costs of cell classification, identification, and concentration calculation in the related art, the inventors have designed a blood imaging analysis system and a method thereof. This method may precisely obtain the area and volume of a blood sample mixture corresponding to a bright-field microscopic magnified digital image based on a simple, low-cost blood sample mixture carrier chip. Thus, it enables accurate cell classification, identification, counting, and cell concentration calculation using bright-field microscopic magnification technology.

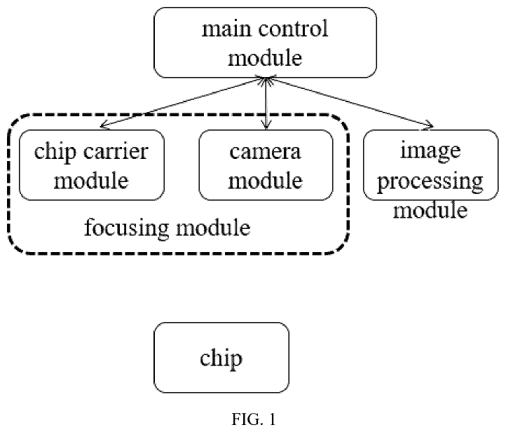

As illustrated in FIG. 1, according to some embodiments, a blood imaging analysis system includes a chip and an imaging analysis main system. The imaging analysis main system includes a main control module, a chip carrier module, a camera module, a focusing module and a digital image processing module.

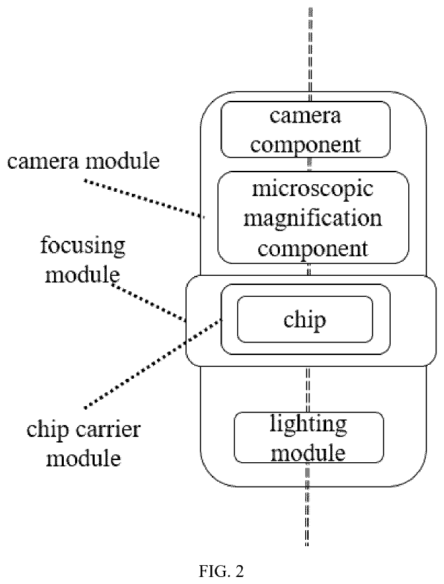

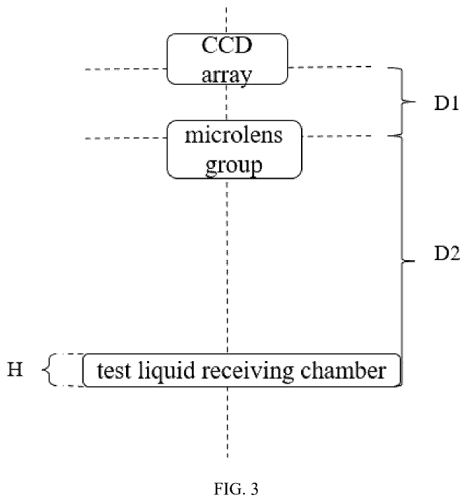

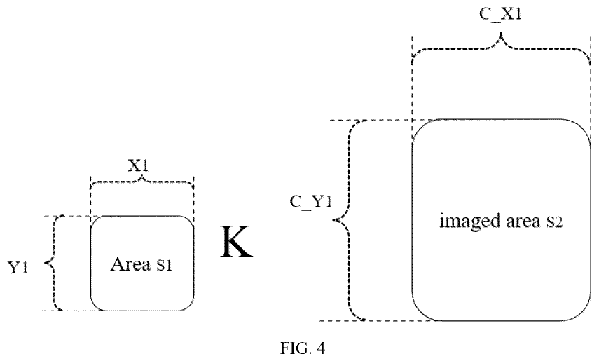

As illustrated in FIG. 2, according to some embodiments, in an optical path of the blood imaging analysis system, the camera module includes a camera component and a microscopic magnification component. As illustrated in FIG. 3, a distance (D1) between an imaging unit having a charge coupled device (CCD) array in the camera component and a center of an imaging microlens group in the microscopic magnification component is equal to a set value. As illustrated in FIG. 4, the magnification factor of the camera module is K, the test area on the chip is S1, the imaged area of the test area (S1) in the camera component is S2, and the unit pixel area of the camera component is SK. The imaging unit having the CCD array may also be an imaging unit having other modes, such as a CMOS imaging unit. The magnification factor (K) in the present disclosure refers to the area magnification factor. The magnification factor (K) may be replaced by the square of a single-dimension magnification factor, or the magnification factor (K) may be expressed as the product of the lateral magnification factor and the longitudinal magnification factor.

As illustrated in FIG. 1 to FIG. 4, in some embodiments, in a blood imaging analysis system, the chip is placed on the chip carrier module; a focusing module drives the chip carrier module or the camera module to move relative to each other, thus changing the positional relationship between the chip carrier module and the camera module and enabling the camera module to obtain a clear digital image which includes a clear image of various blood cells or particles in the blood sample. The camera module obtains a clear digital image, such that S2=S1×K; the pixel count of S2 is designated by M=S2/SK. The digital image processing module is configured for digital image processing, and the digital image processing module obtains the target imaged area (S2) via a formula S2=M×SK based on the pixel points M. Through imaging matching and analyzing blood cells or particles in the imaged area (S2), classification and identification of blood cells or particles in the blood sample mixture is achieved. By counting the different types of blood cells or particles in the imaged area (S2), the count (CN) of each type of the different types of blood cells or particles in the volume (S1×H) is obtained. Alternatively, by counting all types of blood cells or particles in the imaged area (S2), the count (CN) of all types of blood cells or particles in the volume (S1×H) is obtained. Namely, the count (CN) may include each or all of the different types of blood cells or particles in the volume (n×S1×H) as required in practical needs.

The cells and particles in the blood sample mixture are evenly spread in the chip, ensuring the statistical correspondence between the obtained image and the actual blood sample mixture, enabling the cell concentration in the chip to be calculated based on the quantification of the volume (S1×H). How to achieve uniform tiling of cells and particles in the chip may be achieved using methods in the related art, which will not be elaborated here.

In some embodiments, in a blood imaging analysis system not illustrated in the accompanying drawings, the main control module and/or the digital image processing module are configured to calculate the concentration (C) of blood cells or particles in the blood sample mixture using a formula C=CN/(S1×H).

In some embodiments, in a blood imaging analysis system not illustrated in the accompanying drawings, the main control module and/or the digital image processing module are configured to obtain the dilution factor (P) of the original blood in the blood sample mixture, and to calculate the original concentration (CC) of blood cells or particles in the blood sample mixture using the formula: CC=CNxP/(S1×H).

In some embodiments, in a blood imaging analysis system not illustrated in the accompanying drawings, the unit pixel area (SK) of the camera component is calibrated using a standard chip and a camera module with a standard magnification factor (A). The main control module and/or the digital image processing module include an acquisition module for acquiring the unit pixel area (SK) of the camera component. The unit pixel area (SK) of the camera component is obtained through calibration using a standard chip. The standard chip includes a calibration marker, and a known standard size (SL) or a standard area (SS) is obtained through the calibration marker. The camera module captures a clear digital image (magnified by A times) of the calibration marker on the standard chip. The pixel count (MA) of the clear digital image (magnified by A times) of the calibration marker is calculated. The calibrated unit pixel size (PL) is calculated using the formular PL=SL/MA, the calibrated unit pixel area (PS) is derived based on the calibrated unit pixel size (PL), and the calibrated unit pixel area (PS) is designated as the unit pixel area (SK). Alternatively, the calibrated unit pixel area (PS) is calculated using the formula PS=SS/MA, and the calibrated unit pixel area (PS) is designated as the unit pixel area (SK). The calibration markers include lines or graphics of standard width or standard interval, graphics of standard area, and graphics include circles or squares or grids. The unit pixel area (SK) of the camera component is obtained by focusing test on the standard chip.

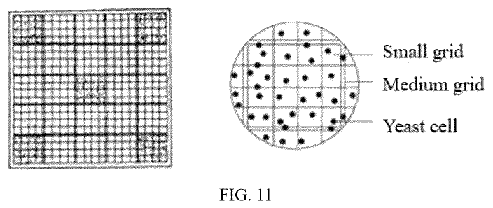

As illustrated in FIG. 11, in order to obtain the size of the corresponding area of the image by the traditional cell counting board, highly accurate small grids and medium grids (double-sided lines) need to be drawn on the test board. The spacing between small grids and the medium grids should approximate the size of target cells (yeast cells in the drawings) to enhance measurement accuracy. However, these small grids and the medium grids not only obstruct visual clarity, but also incur high costs due to requiring highly accurate laser engraving instruments. These small grids and the medium grids have recessed profiles, which affects the flow and distribution of cells. The cells gathered on the edges of the small grids and the medium grids also compromises image recognition accuracy. It is convenient to count single cells using the cell counting board. The counting board for counting a single cell needs to be designed with grids of sizes corresponding to various types of cells of different sizes simultaneously. This is convenient to classify and count cells of different sizes simultaneously, but it further increases the manufacturing complexity and accuracy requirements of the cell counting board.

The solution in the present disclosure only requires a simple chip and a digital image to achieve accurate volume quantification of the blood sample mixture. In the process of blood sample mixture volume quantification, the volume corresponds to the size of the digital image, or, the size of the image corresponds to the volume of the blood sample mixture. This correlation reduces calculation deviations of volume and concentration caused by positional sampling, making the calculation of cell concentration more accurate.

As illustrated in FIG. 3, according to some embodiments, in a blood imaging analysis system, the distance (D1) between the imaging unit in the camera component and the center of the imaging microlens group in the microscopic magnification component is equal to a set value. The distance (D2) between the center of the imaging microlens group in the microscopic magnification component and the bottom of the test liquid receiving chamber in the chip is determined by a grating ruler or adjusted by a focusing algorithm. Depth of field (DOF), also known as focal depth, refers to the range of distances in front of and behind a focused object within which objects appear acceptably sharp in the image captured by a camera lens or other imaging device. The aperture, lens and focal plane to the distance of the object are important factors affecting the depth of field. After focusing is completed, the distance of the clear image presented in the range in front of and behind the focus is within the depth of field.

The depth of field of the digital microscope camera component is limited. After precise focusing, the accuracy of D2 is significantly smaller than the scale of a single cell. When the magnification factor (K) is determined, the relationship between S2 and S1 is determined, and the unit pixel area (SK) of the digital camera component is also a determined value. Through pixel counting, the area of S2 is accurately obtained. Equivalently, by pixel counting, S1 is derived by determining S2. After S1 is determined, using formula S1×H, the volume unit of the test liquid is known. Blood particles in this volume unit are deposited at the bottom. By imaging the bottom and counting particles in the picture, the count of blood particles per volume unit is obtained, achieving the objective of blood imaging analysis. In this way, there is no need to draw small and medium grids in the chip. The measurement of the volume unit relies on the measurement of the unit pixel area (SK) and the measurement of the magnification factor (K). The magnification factor (K) and the unit pixel area (SK) are generally fixed parameters of the microscope camera component. As long as focusing is accurately achieved, the accurate volume unit may be obtained. The distance (D2) may also be measured and determined by a grating ruler.

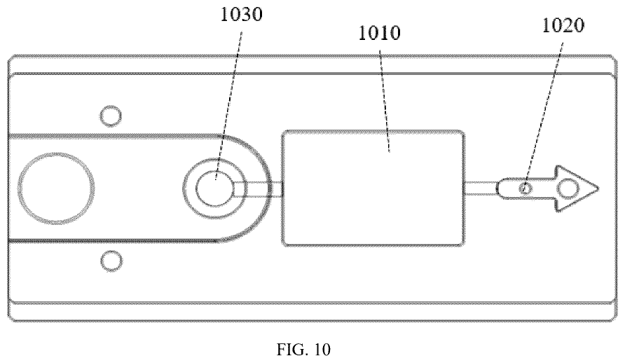

As illustrated in FIG. 10, according to some embodiments, a chip includes a test liquid receiving chamber 1010 for accommodating a blood sample mixture and a blood sample mixture inlet 1030. The test liquid receiving chamber is optically transparent from top to bottom, and the height of the test liquid receiving chamber is a preset chamber height value (H). The test liquid receiving chamber includes a blood sample mixture inlet 1030 and an air outlet 1020. The test liquid enters the test liquid receiving chamber through the blood sample mixture inlet 1030, and the air inside the test liquid receiving chamber is discharged through the air outlet. As the height of the test liquid receiving chamber is small, the air outlet effectively discharges the gas and balances the internal pressure of the test liquid receiving chamber, and the test liquid receiving chamber is not easy to deform. The test liquid receiving chamber 1010 includes a glass which is transparent from top to bottom and a middle interlayer, and a chamber and a pipeline are above the interlayer. The height of the test liquid receiving chamber is very small, and the dimensional accuracy requirement is high. The liquid enters from the inlet 1030, and the gas inside the chamber is discharged out of the air outlet 1020. With the air outlet, the blood sample mixture may quickly enter the test liquid receiving chamber. The test liquid enters the test liquid receiving chamber through the blood sample mixture liquid inlet; the preset chamber height value (H) ranges from 20 um to 400 um (micrometers). The preset chamber height value (H) is a highly accurate measured value (HC) obtained through measurement, and the deviation range between the highly accurate measured value (HC) and the preset chamber height value (H) is controlled within 3%. In other words, HC is controlled within 3% of the preset chamber height value (H), ensuring that the volume deviation between different chips remains within a defined range, thereby limiting the deviation in cell concentration calculation to a defined range when using different chips. The size of the cell is very small, and the accuracy of the height H directly affects the accuracy range of the measurement. The higher the dilution factor, the lower the accuracy requirement for the height (H). During the production process, the HC with highly accurate value is measured by measuring the chips shipped out of the factory, and the chips that do not meet the requirements are eliminated.

In some embodiments, in a blood imaging analysis system not illustrated in the drawings, the preset chamber height value (H) is a highly accurate measured value (HC) obtained through measurement, and the information of the highly accurate measured value (HC) is associated with the barcode or QR code or serial number of the chip. If the accurate value of the height HC is known, the volume may be calculated dynamically using formula: S1×H=S1×HC. As long as the HC is associated with the chip, the pressure of ensuring the accuracy of chip production may be reduced. By embedding the HC within the barcode or QR code or serial number of the chip, the main control module may access the HC of each chip, which may greatly reduce accuracy control challenges during chip production process. Association of the barcode of each chip with the HC of the chip by means of network simplifies the chip barcode. Such an association allows the independent parameters of each chip to be recognized by the main control module to ensure accurate volume calculation of the blood sample mixture.

The magnification factor (K) in the above-mentioned camera module has a value range of 10≤K≤100. The microscopic magnification factor (K) is directly related to the resolution of the camera component in the camera module, and is also related to the imaged area of S1. If S1 is set small, the count of cells obtained in one picture is limited.

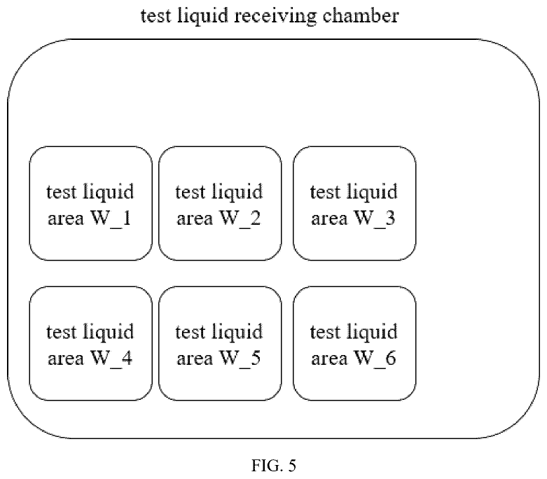

As illustrated in FIG. 5, according to some embodiments, in a blood imaging analysis system, the focusing module drives the chip carrier module or the camera module to move horizontally (left and right and/or forward and backward). The camera module obtains n clear digital images, in which n=6. The digital image processing module performs digital image processing on the n clear digital images. The digital image processing module obtains the target image area (S3) by calculating the pixel count (M3) in the n clear digital images, and achieves classification and identification of blood cells or particles in the blood sample mixture. By counting the blood cells or particles in the image area (S3), the count (CN) of different types of blood cells or particles in the volume (n×S1×H) is obtained. The count (CN) may include each or all of the different types of blood cells or particles in the volume (nxS1×H) as required in practical needs.

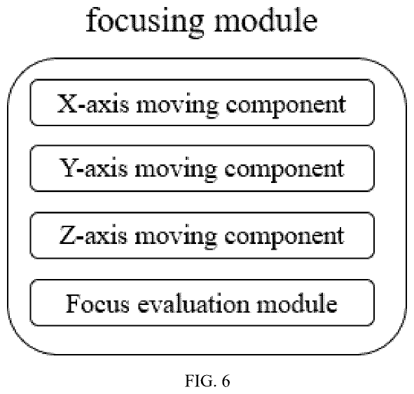

As illustrated in FIG. 5 to FIG. 6, according to some embodiments, in a blood imaging analysis system, the focusing module also includes an X-axis moving component, which drives the chip carrier module to move left and right horizontally. The focusing module also includes a Y-axis moving component, which drives the chip carrier module to move back and forth horizontally. The X-axis moving component and the Y-axis moving component of the focusing module may find the target cells or particles during the focusing process, and place the cells or particles in the center of the field of view to facilitate focusing processing using algorithm. The chip may also be moved to take pictures at different positions. As illustrated in FIG. 5, it may be moved multiple times, i.e. move the test liquid areas W_1 to W_6 to the focus center point respectively, thereby obtaining multiple pictures. In the above-mentioned blood imaging analysis system, the focusing module also includes a Z-axis moving component, which drives the chip carrier module to move vertically with respect to the horizontal plane. The Z-axis moving component may adjust the distance of D2. In order to obtain a high-accuracy image, the moving accuracy of the Z-axis moving component is required to be smaller than the size of the test cells or particles.

As illustrated in FIG. 5, the focusing module drives the chip carrier module or the camera module to move left and right or forward and backward in a horizontal direction, and the camera module obtains n clear digital images. The digital image processing module performs digital image processing on the n clear digital images to obtain the count of different types of blood cells or particles in the volume (n×S1×H). If the pixel of the camera component is low and the magnification factor (K) is high, the actual area obtained by one photo is small and the volume measurement accuracy is low. The measurement accuracy may be improved by taking more digital images and processing multiple photos.

In some embodiments, in a blood imaging analysis system not illustrated in the accompanying drawings, a vertical adjustment module is also included, which is configured to adjust the verticality between the chip carrier module and the camera module. The verticality is related to the freshness of each point in a picture. The device may manually adjust the components to adjust the verticality of the center of the microscopic magnification component and the chip carrier module. If the device is moved, it also needs to be adjusted. It may be adjusted up and down, left and right, with a standard counting board to adjust the picture to be relatively clear; it may also be automatically adjusted by a program using an electric mechanism.

In some embodiments, a blood imaging analysis system not illustrated in the accompanying drawings also includes a chip carrier horizontal adjustment module configured to adjust the horizontality of the chip carrier module. The horizontality has a certain degree of correlation with the verticality between the chip carrier module and the camera module. The horizontality may be adjusted first, and then the verticality between the chip carrier module and the camera module may be adjusted.

The magnification factor (K) of the above-mentioned camera module is obtained by a standard chip focus test. The above-mentioned standard chip includes a calibration pattern, which includes a standard circle or square or grid. The unit pixel area (SK) of the camera component is obtained by performing focus test on the standard chip.

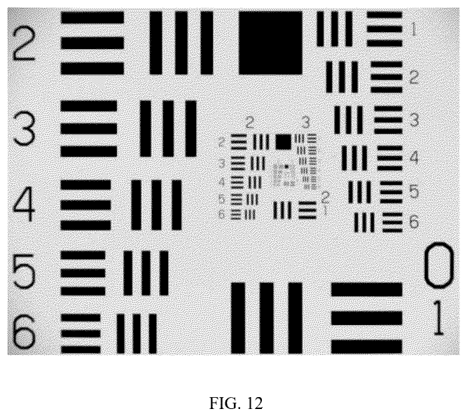

As illustrated in FIG. 12, in some embodiments, the standard chip, i.e., a schematic diagram of a resolution board, is shown. The spacing of any two adjacent black lines in the drawing is designated as a reference for the standard spacing. In some embodiments of the present disclosure, the standard size of the resolution board is 0.55 um, and its accuracy is plus or minus 10%, i.e., 0.055 um. The unit pixel area (SK) of the camera component may be calibrated with this size. In addition, the magnification factor (K) of the camera module may also be calibrated using the standard chip, i.e., the resolution board, as illustrated in FIG. 12. In some embodiments of the present disclosure, the camera pixel size is 2.4 um, achieving sufficient imaging resolution and recognition rates for micrometer-scale platelets, including the smallest size, when microscopically magnified by K times.

In some embodiments, the distance (D1) between the imaging unit in the camera component and the center of the imaging microlens group in the microscopic magnification component is equal to a preset value; the distance (D2) between the center of the imaging microlens group in the microscopic magnification component and the bottom of the test liquid receiving chamber in the chip is determined by a grating ruler or adjusted in place by a focusing algorithm. Due to component and assembly tolerances, deviation exists in the distance (D1) between the imaging unit in the camera component and the center of the imaging microlens group in the microscopic magnification component. Similarly, the distance (D2) between the center of the imaging microlens group in the microscopic magnification component and the bottom of the test liquid receiving chamber in the chip introduces deviation. The above deviations propagate deviation to the magnification factor. If a uniform and fixed magnification factor (K) is configured for subsequent calculations, additional errors will be introduced.

Therefore, in some embodiments of the present disclosure, the magnification factor (K) of the camera module is also calibrated using a standard chip. The calibrated magnification factor (K) is configured for subsequent concentration calculations to reduce systematic errors and concentration calculation errors caused by magnification factor deviations. When the magnification factor (K) of the camera module is calibrated using a standard chip and a camera with a standard unit pixel area (SK), the standard chip includes a calibration marker, and a known standard size (SL) or standard area (SS) is obtained through the calibration marker. The unit pixel area (SK) or unit pixel size (SL) of the camera component is known. The distance (D1) between the imaging unit in the camera component of the camera module and the center of the imaging microlens group in the microscopic magnification component is fixed, and the distance (D2) between the center of the imaging microlens group in the microscopic magnification component and the bottom of the test liquid receiving chamber in the chip is adjusted to obtain a clear image. The clear image includes the calibration marker on the standard chip. The pixel count (SM) of the calibration marker is calculated; and the size (ML) or area (MS) of the calibration marker in the image is calculated based on the pixel count (SM) of the calibration marker; the calibrated magnification factor (K) of the camera module is calculated using the formula: the magnification factor (K)=(the size (ML) of the calibration marker in the image/the unit pixel size (SL)) 2; or the calibrated magnification factor (K) of the camera module is calculated using the formular: the magnification factor (K)=the area of the calibration marker in the image (MS)/the unit pixel area (SK).

Different camera components and systems composed of different microscope magnification components have different magnification factors. The unit pixel area (SK) of different batches of camera components is also different, which brings uncertain factors to accurate measurement. The magnification factor (K) and unit pixel area (SK) may be measured using standard components, i.e. standard chips such as resolution plates or cell counting plates. During the use of the device, different ambient temperatures, or loosening and deformation of system components over time may cause changes in key parameters. Using standard components, the system may be measured and corrected at any time, and the corrected parameters may be designated as the new magnification factor (K) or unit pixel area (SK) to maintain the measurement accuracy of the system at a high level.

The above-mentioned blood sample mixture is obtained by diluting and staining the test blood, and the dilution factor ranges from 10 to 400. The fluidity of the diluted test blood may be enhanced. Generally, it is necessary to dilute the blood to the bottom of the chip in a single layer, and those individual cell particles that are not distributed in a single layer may be identified and processed. A high dilution factor may reduce the accuracy requirements of the height H of the test liquid receiving chamber. However, a high dilution factor requires a high resolution of the camera component, and a range of 10 to 400 is more suitable. The count of different types of blood cells or particles in the above volume (S1×H) is multiplied by the dilution factor (P) to obtain the original concentration of blood cells or particles in the blood using the formular: CC=CN×P/(S1×H). If the count of different types of blood cells or particles in the volume (n×S1×H) is obtained, the original concentration of blood cells or particles is calculated using the formular: CC=(CN1+CN2 . . . +CNn)×P/(n×S1×H), in which CN1, CN2 . . . . CNn are the count of blood cells or particles in each photo of n clear digital images respectively and n is a natural number greater than or equal to 2. The count (CN) may include each or all of the different types of the blood cells or particles in the volume (n×S1×H) as required in practical needs.

The preparation method of the above blood sample mixture is: mixing and diluting the test blood with staining reagent A to form a staining mixture 1; staining for M seconds, and mixing with stabilizing reagent B to form a staining mixture 2. The above staining reagent A includes new methylene blue; the above stabilizing reagent B includes aldehydes; and the above aldehydes include glutaraldehyde and/or formaldehyde. The use of staining reagent A and stabilizing reagent B accelerates the staining time while enhancing flowability of the blood sample mixture, facilitating its entrance into the test liquid receiving chamber.

Some digital image processing modules not illustrated in the accompanying drawings also include a cell classification and recognition module. In the cell classification and recognition module, the sizes of single cells (CL) in the imaged area (S2) are calculated or the per-cell pixel count (MC) is calculated. The primary three-category classifications of red blood cells, white blood cells and platelets are performed according to the single cell size (CL) or the per-cell pixel count (MC).

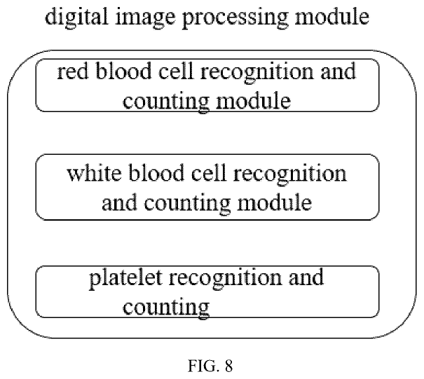

The digital image processing module illustrated in FIG. 8 includes a red blood cell recognition and counting module, a white blood cell recognition and counting module and/or a platelet recognition and counting module based on image matching and recognition using an artificial intelligence (AI) algorithm. Using AI imaging recognition, an AI imaging recognition software is trained with white blood cell or red blood cell or platelet images. The digital image processing module may recognize various cells. On the basis of recognizing various cells, the cells in the imaged area (S2) are counted. Through volume calculation, the count of cells in the diluted blood may be obtained. Multiplying the dilution factor, the count or concentration of various cells or particles per unit volume in the blood may be calculated.

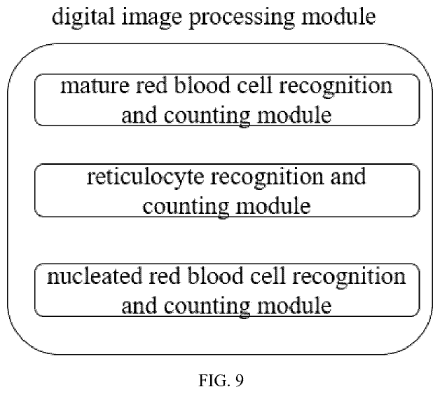

In the digital image processing module illustrated in FIG. 9, the red blood cell recognition and counting module includes a mature red blood cell recognition and counting module, a reticulocyte recognition and counting module and/or a nucleated red blood cell recognition and counting module, which are configured for the secondary three-category classification of red blood cells.

In the digital image processing modules not illustrated in some drawings, the white blood cell recognition and counting module includes a neutrophil recognition and counting module, a lymphocyte recognition and counting module, a monocyte recognition and counting module, an eosinophil recognition and counting module, and a basophil recognition and counting module. The neutrophil recognition and counting module further includes a neutrophil rod-shaped nuclear granulocyte recognition and counting module and a neutrophil segmented nuclear granulocyte recognition and counting module. The white blood cell recognition and counting module is configured for the secondary six-category classification of white blood cells, that is, configured for classifying, recognizing and counting neutrophil rod-shaped nuclear granulocytes, neutrophil segmented nuclear granulocytes, lymphocytes, monocytes, eosinophils, and basophils.

The above blood imaging analysis system may also be configured for imaging analysis of biological fluids. The biological fluids include urine, cerebrospinal fluid, pleural effusion, peritoneal effusion, joint effusion, semen or saliva. These biological fluids contain particles such as cells or proteins. As different body fluids contain different counts of cells or particles, they may be diluted using different dilution and staining reagents, or may be directly imaged without dilution, or stained with high-concentration staining reagents.

A blood imaging analysis method includes diluting and staining an original blood sample to obtain a blood sample mixture, in which the dilution factor (P) of the blood sample mixture ranges from 10 to 400; adding the diluted and stained blood sample mixture into a test liquid receiving chamber of a chip, and allowing blood cells or particles in the sample to settle down to the bottom of the test liquid receiving chamber; the height of the test liquid receiving chamber is a preset chamber height value (H); a microscopic magnification digital imaging system, i.e., a camera module, includes a camera component and a microscopic magnification component; photographing the test liquid receiving chamber using a microscopic magnification digital imaging system with a magnification factor (K); the unit pixel area in the microscopic magnification digital image obtained by the digital imaging system is SK, the test area on the chip is S1, the imaged area of the test area (S1) in the microscopic magnification digital imaging system is S2; obtaining a clear microscopically magnified digital image by focusing the focus pattern or blood cells or particles at the bottom of the chip, such that S2=S1×K; calculating the pixel count of S2 using the formula M=S2/SK; the digital image includes clear images of various blood cells or particles in the blood sample mixture; obtaining the imaged area (S2) by calculating the pixel points M, and realizing classification and identification of blood cells or particles in the blood sample mixture by image matching analysis and processing of blood cells or particles in the imaged area (S2), and obtaining the count (CN) of different types of blood cells or particles in the volume (S1×H) by counting different types of blood cells or particles in the imaged area (S2).

The aforementioned blood imaging analysis method includes the step of calculating the concentration (C) of blood cells or particles in the blood sample mixture. The concentration (C) of blood cells or particles in the blood sample mixture is calculated using formula C=CN/(S1×H).

The above-mentioned blood imaging analysis method includes the step of obtaining the dilution factor (P) of the original blood in the blood sample mixture, and the step of calculating the original concentration (CC) of blood cells or particles in the blood sample mixture. The original concentration (CC) of blood cells or particles in the blood sample mixture is calculated using formula CC=CN×P/(S1×H).

In the above-mentioned blood imaging analysis method, the preset chamber height value (H) ranges from 20 μm to 400 μm. The preset chamber height value (H) is a highly accurate measured value (HC) obtained through measurement, and the deviation range between the highly accurate measured value (HC) and the preset chamber height value (H) is controlled within three percent. Alternatively, the preset chamber height value (H) is a highly accurate measured value (HC) obtained through measurement, and the highly accurate measured value (HC) is associated with the barcode or QR code or serial number of the chip.

The aforementioned blood imaging analysis method includes obtaining n clear digital images at different positions, in which n is a natural number greater than 1; performing digital image processing on the n clear digital images to obtain the count of different types of blood cells or particles in the volume (n×S1×H), in which the count of a single-type of blood cells or particles in the n digital images is CN1 to CNn respectively; calculating the original concentration (CC) of a single-type of blood cells or particles using formula: CC=(CN1+CN2 . . . +CNn)×P/(n×S1×H).

The aforementioned blood imaging analysis method includes the step of obtaining the unit pixel area (SK) of the camera component. The unit pixel area (SK) of the camera component is calibrated using a standard chip and a camera module with a standard magnification factor (A).

The aforementioned blood imaging analysis method includes the step of obtaining the magnification factor (K) of the camera module. The magnification factor (K) of the camera module is calibrated using a standard chip and a camera with a standard unit pixel area of SK.

The blood imaging analysis system and method include a chip and an imaging analysis main system. The height of the test liquid receiving chamber in the chip is set to H; the area magnification factor of the camera module is K; the imaged area of the test area (S1) in the camera component is S2, and the unit pixel area is SK; a clear image including various blood cells or particles is obtained and the formula S2-S1×K is satisfied; the pixel count of S2 is calculated using formula: M=S2/SK. The imaged area (S2) is obtained by calculating the pixel count (M). The image matching analysis and processing of the blood cells or particles in the imaged area (S2) is carried out to achieve classification recognition and counting. The count CN of different types of blood cells or particles in the volume (S1×H) is obtained. The volume measurement of the blood sample mixture in the chip relies on the measurement of the unit pixel area (SK) and the magnification factor (K). The area and volume of the blood sample mixture are determined by the pixel count in the digital image, resulting in high accuracy volume and concentration calculations.

A first technical effect of the above technical solution is as follows. It eliminates the need to draw standard-sized grids (small and medium) on each chip. The measurement of the volume of the blood sample mixture contained in the chip relies on obtaining the unit pixel area (SK) and the magnification factor (K). Thus, the sample area of the blood sample mixture may be determined by the pixel count in the digital image. This volume calculation has high accuracy and small measurement deviation; accordingly, subsequent cell or ion concentration calculations are also more accurate.

A second technical effect of the above technical solution is as follows. The magnification factor (K) and unit pixel area (SK) are generally fixed parameters of the microscope camera component. As long as accurate focusing is achieved, precise volume units may be obtained. The microscope objective has high magnification factor and limited depth of field, so successful focusing ensures precise distance.

A third technical effect of the above technical solution is as follows. Based on the digital image, the precise measurement of the volume of the blood sample mixture in the analysis makes the calculation of the concentration (C) of blood cells or particles in the mixture more accurate. Counting cells within area S2 yields the cell count. Through volume calculation, the count of cells in the diluted blood may be obtained. Multiplying by the dilution factor gives the count per unit volume or concentration of various cells or particles in the blood. Based on the known dilution factor (P) of the original blood in the blood sample mixture, the original concentration (CC) of blood cells or particles may be accurately calculated.

A fourth technical effect of the above technical solution is as follows. Based on the camera module obtaining n clear digital images, cell recognition and counting may be performed within a larger volume range. By capturing and processing multiple digital images, the cell count within a larger volume may be easily obtained, further enhancing the accuracy of cell concentration calculation. Particularly for cells like white blood cells, which have a lower concentration compared to red blood cells, the accuracy of their concentration calculation is thereby improved.

A fifth technical effect of the above technical solution is as follows. The size of cells is extremely small. The accuracy of height H directly affects the measurement accuracy range. The higher the dilution factor, the lower the accuracy requirement for the preset chamber height value (H), and the more likely cells are to settle flat on the bottom layer. The preset chamber height value (H) is a highly accurate measured value (HC) obtained through measurement. This avoids the impact of chamber height deviations caused by the chip manufacturing process on concentration calculation, reduces production process accuracy requirements, and thereby lowers chip manufacturing costs.

A sixth technical effect of the above technical solution is as follows. Information of the highly accurate measured value (HC) is associated with the chip's barcode, QR code, or serial number. During production, the highly accurate value HC may be measured for manufactured chips. The HC information is linked to the chip's barcode, QR code, or serial number, enabling each chip to possess its own preset chamber height value (H). This value may be acquired by the system, thereby improving the accuracy of blood sample mixture volume calculation and enhancing the accuracy of cell concentration calculation. This reduces the accuracy requirements for the chip production process, consequently lowering chip manufacturing costs.

A seventh technical effect of the above technical solution is as follows. Using a standard chip to acquire or calibrate the unit pixel area (SK) of the camera component further improves the calculation accuracy of the imaged area (S2). This avoids deviations in unit pixel area (SK) caused by various factors across different camera components, reduces systematic errors, and enhances the accuracy in calculating the count (CN) of blood cells or particles and the concentration (C) of blood cells or particles.

An eighth technical effect of the above technical solution is as follows. Using a standard chip to acquire or calibrate the magnification factor (K) of the camera module reduces deviations in the magnification system caused by errors in the optical system or other factors. This reduces systematic errors, improves system accuracy, and enables calibration of magnification factor (K) after movement, vibration, or reassembly of the device. Consequently, it maintains accuracy in calculating the count (CN) of blood cells or particles and the concentration (C) of blood cells or particles.

A ninth technical effect of the above technical solution is as follows. In the focusing module, the X-axis movement component drives the chip carrier module to move left and right in a horizontal direction. The Y-axis movement component drives the chip carrier module to move forward and backward in a horizontal direction. This expands the imaging range and coverage in the horizontal plane. The focusing module also includes a Z-axis movement component that drives the chip carrier module to move vertically relative to the horizontal plane. This ensures successful focusing to obtain clear digital images. Vertical alignment adjustment and horizontal leveling adjustment of the chip carrier module further improve imaging and focusing quality, especially when acquiring multiple images, ensuring consistency in image quality.

A tenth technical effect of the above technical solution is as follows. The combined use of staining reagent A and stabilizing reagent B shortens staining time. The stained blood sample mixture exhibits good flow properties, facilitating entry into the test liquid receiving chamber and enabling rapid cell flattening followed by settling down. After staining, AI image recognition may be employed; the digital image processing module may identify various cell types. This enables recognition of more cell types, achieving not only three-category classification (red blood cells, white blood cells, and platelets) but also finer classification of white blood cells and red blood cells. For example, it allows separate classification and concentration calculation for 6 different types of white blood cells and 3 different types of red blood cells, supporting classification of up to 10 cell types.

Although the present disclosure is illustrated and described according to some embodiments and alternative schemes, the present disclosure will not be limited by the specific description in this specification. Other alternative or equivalent components may also be configured to implement the present disclosure.

What is claimed is:

1. A blood imaging analysis system, comprising a chip and an imaging analysis main system;
the imaging analysis main system comprising a main control module, a chip carrier module, a camera module, a focusing module and a digital image processing module;
wherein the chip is arranged on the chip carrier module, the chip comprises a test liquid receiving chamber for receiving a blood sample mixture, the test liquid receiving chamber is transparent from a top to a bottom, and a height of the test liquid receiving chamber is a preset chamber height value (H);
the camera module comprises a camera component and a microscopic magnification component, a magnification factor of the camera module is designated by K; a test area on the chip is designated by S1; an imaged area of the test area (S1) in the camera component is designated by S2, and a unit pixel area of the camera component is designated by SK;
the focusing module is configured to drive the chip carrier module or the camera module to move relative to each other to allow the camera module to obtain a clear digital image, the digital image comprises a clear image of blood cells or particles in the blood sample mixture;
the camera module is configured to obtain the clear digital image by satisfying a formula S2=S1×K; a pixel count (M) of S2 is calculated using a formula M=S2/SK;
the digital image processing module is configured for digital image processing, the digital image processing module is configured to: obtain the imaged area (S2) by calculating the pixel count (M), classify and identify the blood cells or particles in the blood sample mixture by image matching analysis and processing of the blood cells or particles in the imaged area (S2), and obtain a count (CN) of the blood cells or particles in the volume (S1×H) by counting the blood cells or particles in the imaged area (S2).

2. The blood imaging analysis system according to claim 1, wherein the main control module and/or the digital image processing module are configured to calculate a concentration of the blood cells or particles in the blood sample mixture using a formula: C=CN/(S1×H).

3. The blood imaging analysis system according to claim 1, wherein the main control module and/or the digital image processing module are configured to: obtain a dilution factor (P) of an original blood in the blood sample mixture, and calculate an original concentration of the blood cells or particles in the blood sample mixture using a formula: CC=CN×P/(S1×H).

4. The blood imaging analysis system according to claim 1, wherein the focusing module is configured to move the chip carrier module or the camera module left and right horizontally and/or backward and forward horizontally, the camera module is configured to obtain n clear digital images, and the digital image processing module is configured to perform digital image processing on the n clear digital images;
the digital image processing module is configured to: obtain a target image area (S3) by calculating a pixel count (M3) in the n clear digital images, classify and identify the blood cells or particles in the blood sample mixture by image matching analysis and processing of the blood cells or particles in the image area (S3), and obtain the count (CN) the blood cells or particles in the volume (n×S1×H) by counting the blood cells or particles in the image area (S3).

5. The blood imaging analysis system according to claim 1, wherein the unit pixel area (SK) of the camera component is calibrated using a standard chip and the camera module having a standard magnification factor (A).

6. The blood imaging analysis system according to claim 1, wherein a distance (D1) between an imaging unit in the camera component and a center of an imaging microlens group in the microscopic magnification component is equal to a preset value; a distance (D2) between the center of the imaging microlens group in the microscopic magnification component and a bottom of the test liquid receiving chamber in the chip is determined by a grating ruler or adjusted by a focusing algorithm.

7. The blood imaging analysis system according to claim 1, wherein a magnification factor (K) of the camera module is calibrated by a standard chip and a camera with a standard unit pixel area (SK).

8. The blood imaging analysis system according to claim 1, wherein the chip comprises a blood sample mixture liquid inlet, a test liquid is configured to enter the test liquid receiving chamber from the blood sample mixture liquid inlet, the preset chamber height value (H) ranges from 20 μm to 400 μm, the preset chamber height value (H) is a highly accurate measured value (HC) obtained through measurement, and a deviation range between the highly accurate measured value (HC) and the preset chamber height value (H) is controlled within three percent.

9. The blood imaging analysis system according to claim 1, wherein the preset chamber height value (H) is a highly accurate measured value (HC) obtained through measurement, and an information of the highly accurate measured value (HC) is associated with a barcode or a QR code or a serial number of the chip.

10. The blood imaging analysis system according to claim 1, wherein a value range of the magnification factor (K) in the camera module is 10≤K≤100.

11. The blood imaging analysis system according to claim 1, wherein the focusing module further comprises an X-axis moving component configured for driving the chip carrier module to move left and right horizontally; and/or the focusing module further comprises a Y-axis moving component configured for driving the chip carrier module to move backward and forward horizontally.

12. The blood imaging analysis system according to claim 1, wherein the focusing module further comprises a Z-axis moving component for driving the chip carrier module to move vertically.

13. The blood imaging analysis system according to claim 1, further comprising:
a verticality adjustment module for adjusting a verticality between the chip carrier module and the camera module; and
a chip carrier horizontal adjustment module configured for adjusting a horizontality of the chip carrier module.

14. The blood imaging analysis system according to claim 1, wherein the blood sample mixture is obtained by diluting and staining an original blood sample, and a dilution factor (P) ranges from 10 to 400.

15. The blood imaging analysis system according to claim 1, wherein the digital image processing module comprises a cell classification and recognition module;
the cell classification and recognition module is configured to: calculate a single cell size (CL) or a per-cell pixel count (MC) of each of the blood cells or particles in the imaged area (S2), and perform a primary three-category classification of red blood cells, white blood cells and platelets according to the single cell size (CL) or the per-cell pixel count (MC).

16. The blood imaging analysis system according to claim 14, further comprising a blood sample mixture preparation module for preparing the blood sample mixture, wherein a method for preparing the blood sample mixture used in the blood sample mixture preparation module comprises:
mixing an original blood sample with a staining reagent A to form a staining mixture 1;
staining for M seconds, and mixing with a stabilizing reagent B to form a staining mixture 2; a range of M being 30 seconds to 360 seconds;
wherein the staining reagent A comprises new methylene blue;
the stabilizing reagent B comprises aldehydes.

17. The blood imaging analysis system according to claim 16, wherein the digital image processing module comprises a red blood cell recognition and counting module, a white blood cell recognition and counting module and/or a platelet recognition and counting module based on image matching and recognition using an artificial intelligence algorithm;
the red blood cell recognition and counting module comprises a mature red blood cell recognition and counting module, a reticulocyte recognition and counting module and/or a nucleated red blood cell recognition and counting module; the red blood cell recognition and counting module is configured for a secondary three-category classification of red blood cells;
the white blood cell recognition and counting module includes a neutrophil recognition and counting module cell recognition and counting module, a lymphocyte recognition and counting module, a monocyte recognition and counting module, an eosinophil recognition and counting module, and a basophil recognition and counting module; the neutrophil recognition and counting module further comprises a neutrophil rod-shaped nuclear granulocyte recognition and counting module, a neutrophil segmented nuclear granulocyte recognition and counting module;
the white blood cell recognition and counting module is configured for the a secondary six-category classification of white blood cells, classifying and counting neutrophil rod-shaped nuclear granulocytes, neutrophil segmented nuclear granulocytes, lymphocytes, monocytes, eosinophils, and basophils.

18. An imaging analysis system, comprising a blood imaging analysis system, the blood imaging analysis system comprising a chip and an imaging analysis main system;
the imaging analysis main system comprising a main control module, a chip carrier module, a camera module, a focusing module and a digital image processing module;
wherein the chip is arranged on the chip carrier module, the chip comprises a test liquid receiving chamber for receiving a blood sample mixture, the test liquid receiving chamber is transparent from a top to a bottom, and a height of the test liquid receiving chamber is a preset chamber height value (H);
the camera module comprises a camera component and a microscopic magnification component, a magnification factor of the camera module is designated by K; a test area on the chip is designated by S1; an imaged area of the test area (S1) in the camera component is designated by S2, and a unit pixel area of the camera component is designated by SK;
the focusing module is configured to drive the chip carrier module or the camera module to move relative to each other to allow the camera module to obtain a clear digital image, the digital image comprises a clear image of blood cells or particles in the blood sample mixture;
the camera module is configured to obtain the clear digital image by satisfying a formula S2=S1×K; a pixel count (M) of S2 is calculated using a formula M=S2/SK;
the digital image processing module is configured for digital image processing, the digital image processing module is configured to: obtain the imaged area (S2) by calculating the pixel count (M), classify and identify the blood cells or particles in the blood sample mixture by image matching analysis and processing of the blood cells or particles in the imaged area (S2), and obtain a count (CN) of each of different types of the blood cells or particles in the volume (S1×H) by counting each of the different types of the blood cells or particles in the imaged area (S2);
the imaging analysis system is configured for imaging of biological fluids; the biological fluids comprise any one of urine, cerebrospinal fluid, pleural effusion, peritoneal effusion, joint effusion, semen or saliva.

19. A blood imaging analysis method, comprising the following steps:
diluting and staining an original blood sample to obtain a blood sample mixture, wherein a dilution factor (P) of the blood sample mixture ranges from 10 to 400;
adding the blood sample mixture into a test liquid receiving chamber of a chip, and precipitating blood cells or particles in the blood sample mixture to a bottom of the test liquid receiving chamber; wherein a height of the test liquid receiving chamber is a preset chamber height value (H);
photographing the test liquid receiving chamber using a microscopic magnification digital imaging system with a magnification factor (K), wherein a unit pixel area in a microscopic magnification digital image obtained by the digital imaging system is SK, a test area on the chip is S1, and an imaged area of the test area (S1) in the microscopic magnification digital image system is S2;
obtaining a clear microscopically magnified digital image by focusing a focus pattern or blood cells or particles at a bottom of the chip and satisfying a formula S2=S1×K; wherein a pixel count (M) of S2 is calculated using a formula M=S2/SK, the digital image comprises clear images of blood cells or particles in the blood sample mixture;
obtaining the imaged area (S2) by calculating the pixel count (M), realizing classification and identification of the blood cells or particles in the blood sample mixture by image matching analysis and processing of the blood cells or particles in the imaged area (S2), and obtaining a count (CN) of the blood cells or particles in a volume of S1×H by counting the blood cells or particles in the imaged area (S2).

20. The blood imaging analysis method according to claim 19, further comprising the step of calculating a concentration (C) of the blood cells or particles in the blood sample mixture;
wherein the concentration (C) of the blood cells or particles in the blood sample mixture is calculated using a formula C=CN/(S1×H).

21. The blood imaging analysis method according to claim 19, further comprising the step of obtaining the dilution factor (P) of the original blood in the blood sample mixture,
and the step of calculating an original concentration (CC) of the blood cells or particles in the blood sample mixture;
wherein the original concentration (CC) of blood cells or particles in the blood sample mixture is calculated using a formula CC=CN×P/(S1×H).

22. The blood imaging analysis method according to claim 19, wherein the preset chamber height value (H) ranges from 20 μm to 400 μm, the preset chamber height value (H) is a highly accurate measured value (HC) obtained through measurement, a deviation range between the highly accurate measured value (HC) and the preset chamber height value (H) is controlled within three percent; or the preset chamber height value (H) is a highly accurate measured value (HC) obtained through measurement, and an information of the highly accurate measured value (HC) is associated with a barcode or a QR code or a serial number of the chip.

23. The blood imaging analysis method according to claim 19, further comprising:
obtaining n clear digital images at different positions, wherein n is a natural number greater than 1;
performing digital image processing on the n clear digital images to obtain a count of each or all of different types of the blood cells or particles in a volume of n×S1×H, wherein the count of each or all of the different types of blood cells or particles in the n digital images is CN1 to CNn respectively; and
calculating an original concentration (CC) of each or all of the different types of the blood cells or particles using a formula CC=(CN1+CN2 . . . +CNn)×P/(n×S1×H).

24. The blood imaging analysis method according to claim 19, comprising the step of obtaining a unit pixel area (SK) of a camera component;
wherein the unit pixel area (SK) of the camera component is calibrated using a standard chip and a camera module having a standard magnification factor (A).

25. The blood imaging analysis method according to claim 19, comprising the step of obtaining a magnification factor (K) of a camera module;
wherein the magnification factor (K) of the camera module calibrated using a standard chip and a camera having a standard unit pixel area of SK.
